(19) United States
(12) Patent Application Publication
(10) Pub. No.: US 2025/0278455 A1
(43) Pub. Date: Sep. 4, 2025

(54) ARITHMETIC PROCESSING OFFLOAD SYSTEM, ARITHMETIC PROCESSING OFFLOAD METHOD AND PROGRAM

(71) Applicant: Nippon Telegraph and Telephone Corporation, Tokyo (JP)

(72) Inventors: Shogo SAITO, Musashino-shi, Tokyo (JP); Kei FUJIMOTO, Musashino-shi, Tokyo (JP)

(21) Appl. No.: 18/855,679

(22) PCT Filed: Apr. 21, 2022
(86) PCT No.: PCT/JP2022/018480

§ 371 Date: Oct. 10, 2024

(51) Int. Cl. G06F 17/17

(52) U.S. Cl. CPC G06F 17/17

(57) ABSTRACT

A server includes: a function call information receiver-parser part that extracts function call information from data received from a client; a subsequent function necessity determination part that determines whether a callee function is indicated by the function call information; and a subsequent function proxy execution part that, when it is determined that a callee function is indicated, instructs a function execution part to perform proxy execution of a subsequent function corresponding to the callee function. The client includes a subsequent function call proxy responder part that, upon reception of a notification of an execution result of the callee function from the server, notifies a user application of a response of the callee function for which the execution result has been received, and responds, as a proxy of the server, to a call to the subsequent function, which call is made by the user application in response to the notification.

### CROSS-REFERENCE TO RELATED APPLICATIONS

This is a National Stage Application of PCT Application No. PCT/JP2022/018480, filed on Apr. 21, 2022. The disclosure of the prior application is considered part of the disclosure of this application, and is incorporated in its entirety into this application.

### BACKGROUND

### Technical Field

The present invention relates to an arithmetic processing offload system, an arithmetic processing offload method, and a program.

### Background Art

With the progress of cloud computing, it is becoming more common to offload partial processing including a large amount of arithmetic operation from a client machine deployed at a user site to a server at a remote site (such as a data center located in the vicinity of a user) via a network (hereinafter, referred to as an NW) in order to simplify the configuration of the client machine.

FIG. 14 is an explanatory diagram illustrating a device configuration of an offload system operating via an NW.

As illustrated in FIG. 14, the offload system via an NW 1 includes a client 10 deployed at a user site and a server 50 connected to client 10 via NW 1.

Client 10 includes client hardware (HW) 20, an operating system (OS) 30, and an application (hereinafter referred to as an APL as appropriate) 40.

APL 40 includes a user application part 41, a function group 42, and a transfer part 43 composed of middleware. Function group 42 is of an ACC (Accelerator: computation accelerator device) utilization IF specification including Open Computing Language (OpenCL) or the like.

A client application calls a plurality of standard functions and APIs to perform arithmetic processing. The functions include a function “with limitations on the sequentiality of calling and completion of the previous function” such as an enqueue function and a dequeue function.

Client 10 is equipped with a network interface card (NIC) 21 mounted on client HW 20.

User application part 41 is a program executed in a user space. The offload system operating via NW is constructed on the premise of utilizing a defined application programming interfaces (APIs) such as OpenCL, and performs input and output with these APIs.

User application part 41 is an application that operates on client 10, and conforms to a standard application programming interface (API) for accessing ACC. User application part 41 operating on client 10 is assumed to perform image processing and the like and thus requires low computation latency (latency).

Server 50 includes: server HW 60; an OS 70; and an APL 80, and on the APL 80, a function execution part 81 composed of middleware for offloading; and a function runtime 82.

Server 50 is equipped with an NIC 61 mounted on server HW 60.

Client 10 and server 50 can communicate with each other via the respective NICs 21 and 61 and NW 1.

The offload system illustrated in FIG. 14 preferably satisfies the following Requirements 1 to 3.

Requirement 1: An interface on which the client application operates does not need to be changed (transparency).

Requirement 2: The time from the time the client application calls a plurality of functions to the time the client application receives the result, i.e., the time from calling the first function to acquiring the result of execution of the last function, is short (minimum), i.e., low latency.

Requirement 3: The resource consumption of the NW and the CPU while the client application performs offload processing via the NW is small (resource saving).

As an existing technique of transparent accelerator processing offloading via NW, “Remote offloading by packetization of function name-argument of accelerator standard IF functions and NW transfer” is known (see Non-Patent Literature 1).

### CITATION LIST

### Non-Patent Literature

Non-Patent Literature 1: “rCUDA v20.07alpha User's Guide,” The rCUDA Team, July 2020., [online], [Retrieved Apr. 4, 2022], the Internet <URL: http://www.rcuda.net/pub/rCUDA_guide.pdf>

### SUMMARY OF THE INVENTION

### Technical Problem

In the offload system described in Non-Patent Literature 1, function call information of the client app is transferred via a NW to perform the offloading without making changes to the application. At this time, calls to a plurality of functions are executed in the same sequence as the client application has requested.

In the case of the existing technique, as the functions are called in the same sequence as the client application has requested, the satisfiability of the requirements differs for each call pattern. Due to this, the following problems arise.

That is, (1) in a case where a plurality of functions is called synchronously, the latency increases although resource saving is achieved.

(2) When a plurality of functions is called asynchronously, low latency is achieved but the resource is large. Hereinbelow, a specific description will be given with reference to FIGS. 15 and 16.

### <Pattern 1>: Case of Calling a Plurality of Functions Synchronously

FIG. 15 is a diagram illustrating a control sequence <Pattern 1> in a case where a plurality of functions are called synchronously between client 10 and server 50 of the offload system illustrated in FIG. 14.

The offload system illustrated in FIG. 14 is an arithmetic processing offload system in which client 10 offloads processing of an application that calls a plurality of functions with execution sequentiality to perform arithmetic processing to server 50 to perform the arithmetic processing.

The functions with execution sequentiality are an enqueue function (callee function) intended for enqueuing that requires subsequent execution, and a dequeue function (subsequent function) intended for dequeuing that is to be subsequently executed after execution of the enqueue function. Other functions with execution sequentiality include a preparation function for preparation and an execution function to be executed after execution of the preparation function.

User application part 41 of client 10 calls (reference sign a in FIG. 15) an enqueue function. Transfer part 43 transfers (reference sign b in FIG. 15) the enqueue function to function execution part 81 of server 50 via the NW (NW 1 in FIG. 14). Note that, in the following description, description of NIC 21 and NIC 61 (FIG. 14) for connecting through NW is omitted.

Function execution part 81 of server 50 executes (reference sign c in FIG. 15) the enqueue function with function runtime 82. Then, function runtime 82 executes (reference sign d in FIG. 15) queue processing.

Server 50 transmits (reference sign e in FIG. 15) an enqueue function execution result to transfer part 43 of client 10 via the NW. Transfer part 43 passes (reference sign f in FIG. 15) the enqueue function execution result received from server 50 to user application part 41 as the enqueue function response.

Upon reception of the enqueue function response, user application part 41 performs (reference sign g in FIG. 15) calling a dequeue function.

Transfer part 43 transfers (reference sign h in FIG. 15) the dequeue function to server 50 via the NW. Function execution part 81 of server 50 executes (reference sign i in FIG. 15) the dequeue function with function runtime 82.

Server 50 transmits (reference sign j in FIG. 15) the dequeue function execution result to transfer part 43 of client 10 via the NW. Transfer part 43 performs a dequeue function response (reference sign k in FIG. 15) of passing the dequeue function execution result received from server 50 to user application part 41.

Note that it is conceivable to perform the “dequeue function execution” of both client 10 and server 50 by using not only polling but also an interrupt.

In a case where a plurality of functions are called synchronously, as indicated by reference signs b, e, h, and j in FIG. 15, two or more NW round trip latencies become the minimum latency. Due to this, there is a problem in that the low latency of Requirement 2 described above is not satisfied.

### <Pattern 2>: Case of Calling a Plurality of Functions Asynchronously

FIG. 16 is a diagram illustrating a control sequence <Pattern 2> in a case where a plurality of functions are called asynchronously between client 10 and server 50 of the offload system illustrated in FIG. 14. The same processing as those in FIG. 15 are denoted by the same reference signs, and descriptions thereof are omitted.

User application part 41 of client 10 calls (reference sign a in FIG. 16) an enqueue function. Thereafter, user application part 41 makes a call (reference signs g1 and g2 in FIG. 16) to a dequeue function without waiting for the result of the enqueue function. Here, the dequeue function is executed asynchronously and by busy polling without waiting for the result of the enqueue function.

Transfer part 43 transfers (reference signs h1 and h2 in FIG. 16) a plurality of dequeue function calls to function execution part 81 of server 50 via the NW. Function execution part 81 of server 50 executes (reference signs i1 and i2 in FIG. 16) the dequeue function with function runtime 82. Here, an assumption is made such that the dequeue function execution (reference sign i1 in FIG. 16) is “failure” and the dequeue function execution (reference sign i2 in FIG. 16) is “success”, and server 50 transmits (reference signs j1 and j2 in FIG. 16) the respective dequeue function execution results to transfer part 43 of client 10 via the NW. Transfer part 43 performs a dequeue function response (reference signs k1 and k2 in FIG. 16) of passing each dequeue function execution result received from server 50 to user application part 41.

Note that it is conceivable to perform the “dequeue function execution” of both the client and the server by using not only polling but also an interrupt.

When a plurality of functions are called asynchronously, the number of times of calls (number of arrows: reference signs b, h1, h2, j1, j2, and e in FIG. 16) to the subsequent function is large, and NW and CPU resources are consumed. Due to this, there is a problem in that the resource saving of Requirement 3 described above is not satisfied.

The present invention has been made in view of such a background, and an object thereof is to achieve reduction in the number of times of function calls via an NW and low latency, while maintaining the interface of functions.

### Means for Solving the Problem

In order to solve the above problems, an aspect of the present invention is an arithmetic processing offload system including a client and a server connected to the client via a network such that the client offloads processing of an application that calls a plurality of functions with execution sequentiality to perform arithmetic processing to the server to perform the arithmetic processing, the plurality of functions with execution sequentiality including a callee function and a subsequent function to be subsequently executed after execution of the callee function. The server includes: a function execution part configured to execute a designated function: a function call information reception part configured to extract function call information including information capable of identifying a function and an argument from data received from the client: a subsequent function necessity determination part configured to receive the function call information from the function call information reception part and to determine whether the function call information indicates the callee function; and a subsequent function proxy execution part configured to, when the subsequent function necessity determination part determines that the function call information indicates the callee function, instructs the function execution part to perform proxy execution of the subsequent function.

### Advantageous Effects of Invention

According to the present invention, it is possible to achieve both reduction in the number of times of function calls via the NW and low latency while maintaining the interface of the function.

### BRIEF DESCRIPTION OF DRAWINGS

FIG. 1 is a schematic configuration diagram of an arithmetic processing offload system according to an embodiment of the present invention.

FIG. 2 is a diagram illustrating a configuration example of a function-argument-data packet of the arithmetic processing offload system according to the embodiment of the present invention.

FIG. 3 is a diagram illustrating a control sequence <Pattern 1> in a case where a plurality of functions are called synchronously between a client and a server of the arithmetic processing offload system according to the embodiment of the present invention.

FIG. 4 is a diagram illustrating a control sequence <Pattern 2> in a case where a plurality of functions are called asynchronously between the client and the server of the arithmetic processing offload system according to the embodiment of the present invention.

FIG. 5 is an operation explanatory diagram illustrating “execution of an enqueue function” of the arithmetic processing offload system according to the embodiment of the present invention.

FIG. 6 is an operation explanatory diagram illustrating “a response of an enqueue function” of the arithmetic processing offload system according to the embodiment of the present invention.

FIG. 7 is an operation explanatory diagram illustrating “automatic execution of a dequeue function” of the arithmetic processing offload system according to the embodiment of the present invention.

FIG. 8 is an operation explanatory diagram illustrating “completion of a dequeue function” of the arithmetic processing offload system according to the embodiment of the present invention.

FIG. 9 is a control sequence illustrating offload processing of the arithmetic processing offload system according to the embodiment of the present invention.

FIG. 10A is a flowchart illustrating transmission-time offload processing by the client of the arithmetic processing offload system according to the embodiment of the present invention.

FIG. 10B is a flowchart illustrating the transmission-time offload processing by the client of the arithmetic processing offload system according to the embodiment of the present invention.

FIG. 11A is a flowchart illustrating offload processing of the server of the arithmetic processing offload system according to the embodiment of the present invention.

FIG. 11B is a flowchart illustrating the offload processing of the server of the arithmetic processing offload system according to the embodiment of the present invention.

FIG. 12 is a flowchart illustrating reception-time offload processing by the client of the arithmetic processing offload system according to the embodiment of the present invention.

FIG. 13 is a hardware configuration diagram illustrating an example of a computer that implements the functions of the client of the arithmetic processing offload system according to the embodiment of the present invention.

FIG. 14 is an explanatory diagram illustrating a device configuration of an offload system operating via an NW.

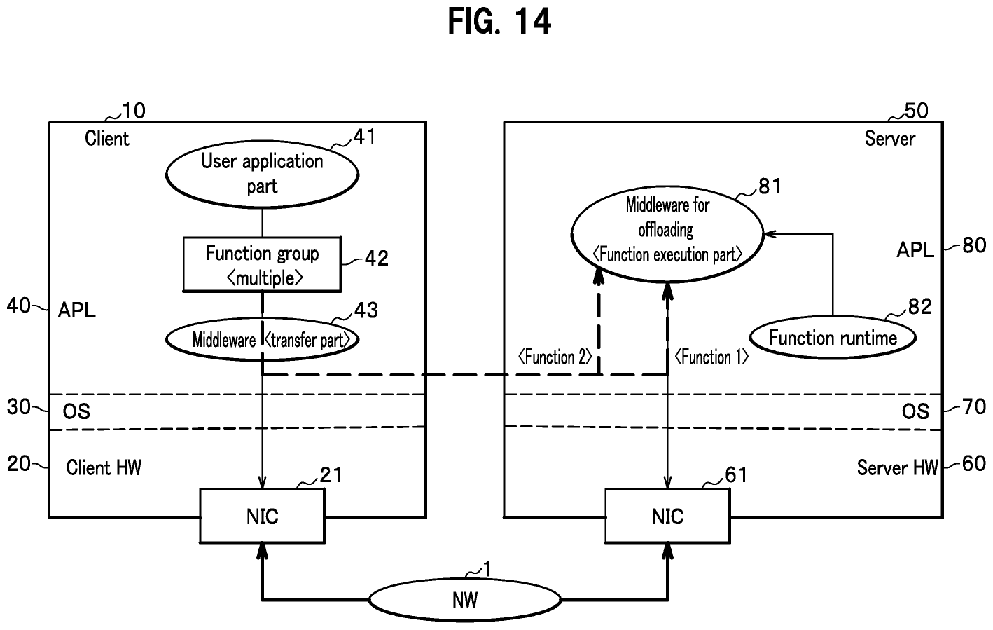

FIG. 15 is a diagram illustrating a control sequence <Pattern 1> in a case where a plurality of functions are called synchronously between the client and the server of the offload system illustrated in FIG. 14.

FIG. 16 is a diagram illustrating a control sequence <Pattern 2> in a case where a plurality of functions are called asynchronously between the client and the server of the offload system illustrated in FIG. 14.

### DESCRIPTION OF EMBODIMENTS

Hereinbelow, an arithmetic processing offload system and the like in a mode for carrying out the present invention (hereinafter, referred to as “present embodiment”) will be described with reference to the drawings.

### EMBODIMENT

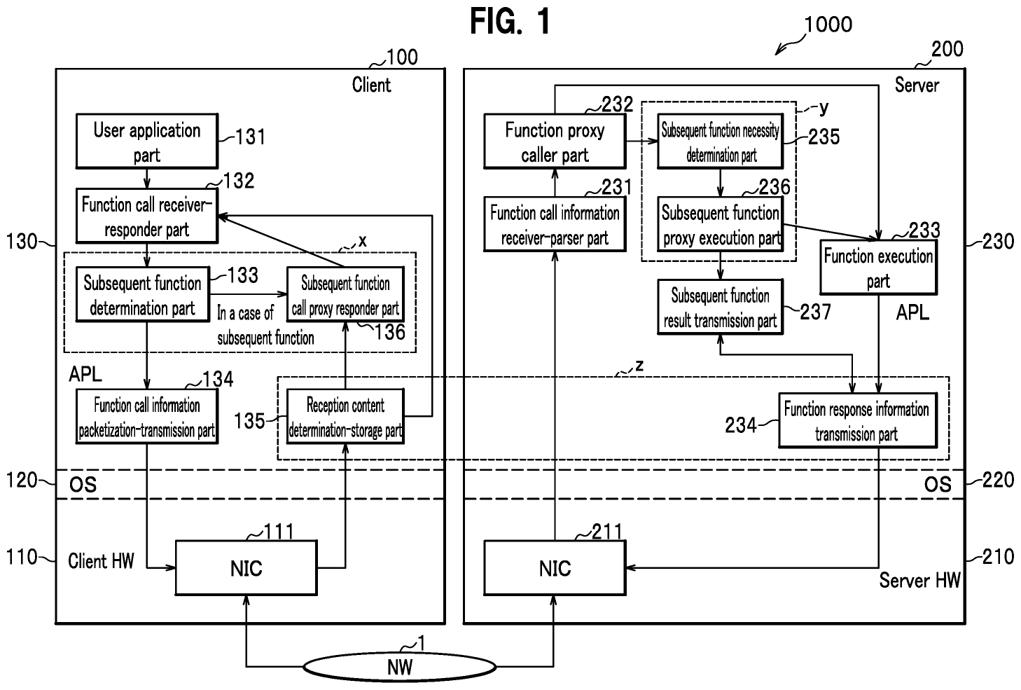

FIG. 1 is a schematic configuration diagram of an arithmetic processing offload system according to an embodiment of the present invention. The present embodiment is an example applied to offload processing using eXpress Data Path (XDP)/Berkeley Packet Filter (eBPF) of Linux (registered trademark).

As illustrated in FIG. 1, an arithmetic processing offload system 1000 includes a client 100 and a server 200 connected via an NW 1, and is an offload system in which the client 100 offloads processing of an application that calls a plurality of functions with execution sequentiality to perform arithmetic processing to the server to perform the arithmetic processing.

### [Client 100]

Client 100 includes client HW 110, an OS 120, and an APL 130.

### <<Client HW 110>>

The client HW 110 includes an NIC 111.

NIC 111 is NIC hardware that implements an NW interface.

In <Transmission Pattern>, NIC 111 receives “transmission data” from a function call information packetization-transmission part 134 as an input and passes the “transmission data” to NW 1 as an output.

In <Reception Pattern>, NIC 111 receives “reception data” from NW 1 as an input, and passes the “reception data” to a reception content determination-storage part 135 as an output.

### <<APL 130>>

APL 130 includes a user application part 131, a function call receiver-responder part 132, a subsequent function determination part 133, the function call information packetization-transmission part 134, the reception content determination-storage part 135, and a subsequent function call proxy responder part 136.

Subsequent function determination part 133 and subsequent function call proxy responder part 136 constitute a function group (enclosed by dashed line x in FIG. 1) of responding to calls to subsequent functions as a proxy.

### <User Application Part 131>

User application part 131 is a program executed in a user space. It is constructed on the premise of using the APIs defined by OpenCL, DPDK BBDevAPI (registered trademark), or the like, and performs input/output with these APIs. User application part 131 has a “function name-argument” for function call receiver-responder part 132 as an output. User application part 131 receives a “function execution result” from function call receiver-responder part 132 as an input.

User application part 131 may have a result output destination such as image drawing on a display as another output destination.

<Function Call receiver-responder Part 132>

Function call receiver-responder part 132 is implemented as middleware having an IF compatible with a predetermined API. It has an IF equivalent to a defined API such as OpenCL or DPDK BBdevAPI, and receives API calls from the user. Function call receiver-responder part 132 is provided as a binary file separate from the user application, and is implemented in a “dynamic library format” in which dynamic linking and calls are performed at the time of execution.

In <Call Pattern>, function call receiver-responder part 132 receives a “function name (information capable of identifying a function)-argument” from user application part 131 as an input, and passes the “function name-argument” to subsequent function determination part 133 as an output.

Here, the “function name” is an example of information capable of identifying a function. The information capable of identifying a function is identification of classification of the function (identifier of the function), and includes, for example, an ID (number) of the function in addition to the “function name”. Hereinbelow; description will be given using “function name” as identification of classification of a function.

In <Response Pattern>, function call receiver-responder part 132 receives an “execution result of a function” from reception content determination-storage part 135, and responds, as an output, to user application part 131 with the “execution result of the function”.

Function call receiver-responder part 132 may be in a “static library format” where function call receiver-responder part 132 is linked to the user application at the time of generating the program and is to be executed integrally.

### <Subsequent Function Determination Part 133>

Subsequent function determination part 133 determines, based on an input function name, whether the function name matches a subsequent function (dequeue function), and according to the determination result, select whether to execute a function call via the network (function call information packetization-transmission part 134) or a local function call (subsequent function call proxy responder part 136).

Subsequent function determination part 133 holds a “list of functions entailing a subsequent function” (not illustrated) for subsequent function determination, and compares the input function name with the “list of functions entailing a subsequent function” to determine whether the input function name matches a subsequent function.

Subsequent function determination part 133 receives the “function name-argument” from function call receiver-responder part 132 as an input. Subsequent function determination part 133 passes, as an output, the “function name-argument” to function call information packetization-transmission part 134 or subsequent function call proxy responder part 136.

Note that the determination of matching the subsequent function may be made by making an inquiry to an external server and making a determination based on the result.

In addition, subsequent function determination part 133 may have a function of predicting a timing of the result reception by reception content determination-storage part 135 based on the NW latency or the like necessary for communication between NIC 111 and an NIC 211 (described later) and waiting for a response until that timing, thereby reducing the total number of times of function executions.

<Function Call Information Packetization-Transmission part 134>

Function call information packetization-transmission part 134 converts the input function name-argument into data as an L2 frame and the payload thereof that can be transmitted by NIC 111 and NIC 211. Function call information packetization-transmission part 134 serializes the input function name-multiple arguments according to a predetermined format into a single piece of data.

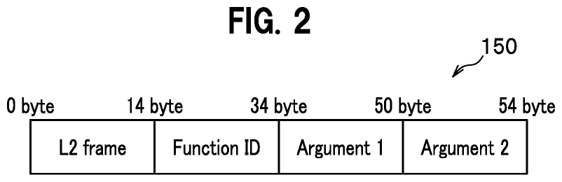

FIG. 2 is a diagram illustrating a configuration example of a function-argument-data packet 150.

The function-argument-data packet 150 is formatted with an L2 frame (0 to 14 byte), a function ID (to 34 byte), an argument 1 (to 50 byte), and an argument 2 (to 54 byte).

Function call information packetization-transmission part 134 receives the “function name-argument” from subsequent function determination part 133 as an input. Function call information packetization-transmission part 134 passes “transmission data” to NIC 111 as an output.

Here, the data format may be such that the data is added with not only the L2 frame but also L3 and L4 headers. In addition, the L3/L4 protocol may be Transmission Control Protocol/Internet Protocol (TCP/IP) or may be a protocol other than TCP/IP in which a part of L3/L4 is partially omitted and only L3 is used.

The packet format may include not only the function name-argument but also an ID capable of uniquely identifying the accelerator to be utilized.

In addition, in a case where the argument size is large, a function of dividing into a plurality of packets may be provided. In this case, control data for notification of the last packet illustrated in FIG. 2 is added to the last divided packet.

### <Reception Content Determination-Storage Part 135>

Reception content determination-storage part 135 deserializes received packet data to extract a “function name” and a “function execution result”. Reception content determination-storage part 135 determines the type of the function based on the “function name”, and when it is not of “subsequent function”, notifies function call receiver-responder part 132 of the “function execution result”. When it is of “subsequent function”, reception content determination-storage part 135 stores the result in preparation for an acquisition request for the “function execution result” from subsequent function call proxy responder part 136.

Reception content determination-storage part 135 receives packet data from NIC 111 as an input.

In <Output Pattern 1>, when the type of the function is not of “subsequent function”, reception content determination-storage part 135 responds, as an output, to function call receiver-responder part 132 with the “function execution result”. As an input, reception content determination-storage part 135 receives a request for acquiring the function execution result from subsequent function call proxy responder part 136.

In <Output Pattern 2>, as an input, reception content determination-storage part 135 responds to subsequent function call proxy responder part 136 with the “function execution result”.

The trigger of the result notification from reception content determination-storage part 135 to subsequent function call proxy responder part 136 may be not of the polling type triggered by an inquiry from subsequent function call proxy responder part 136 and may be of a form where notification is actively made from reception content determination-storage part 135. For example, notification is performed from reception content determination-storage part 135 using an interrupt function of the CPU.

### <Subsequent Function Call Proxy Responder Part 136>

Subsequent function call proxy responder part 136, upon reception of a notification of an execution result of a callee function (enqueue function) from the server 200 side, notifies user application part 131 of the response of the callee function for which the execution result has been received, and performs, for the subsequent function (dequeue function) called by user application part 131 in response to the notification of the response of the callee function, a response of the subsequent function as a proxy of the server side.

Subsequent function call proxy responder part 136 references the “function execution result” held by reception content determination-storage part 135 based on the input “function name-argument”, and completes a result response of the function within the client. Subsequent function call proxy responder part 136 responds to function call receiver-responder part 132, which is the caller, with the execution result of the function, based on the “execution result of the function” acquired from reception content determination-storage part 135.

When subsequent function call proxy responder part 136 references reception content determination-storage part 135, if an “execution result of the function” is present, subsequent function call proxy responder part 136 notifies function call receiver-responder part 132 of the execution result. When no “function execution result” is present, subsequent function call proxy responder part 136 performs a response indicative of no data present.

Subsequent function call proxy responder part 136 receives the “function name-argument” from subsequent function determination part 133 as an input. Subsequent function call proxy responder part 136 responds, as an output, to function call receiver-responder part 132 with the execution result of the function.

### [Server 200]

As illustrated in FIG. 1, server 200 includes a server HW 210, an OS 220, and an APL 230.

### <<Server HW 210>>

As illustrated in FIG. 1, server HW 210 includes NIC 211.

NIC 211 is NIC hardware that implements an NW interface.

In <Reception Pattern>, NIC 211 receives “reception data” from client 100 via NW 1 as an input, and passes the “reception data” to a function call information receiver-parser part 231 as an output.

In <Transmission Pattern>, NIC 211 receives a “function name” and a “function execution result” from a function response information transmission part 234 as inputs, and passes the “function name” and the “function execution result” to NIC 111 of client 100 via NW 1.

### <<APL 230>>

As illustrated in FIG. 1, APL 230 includes function call information receiver-parser part 231 (function call information reception part), a function proxy caller part 232, a function execution part 233, function response information transmission part 234, a subsequent function necessity determination part 235, a subsequent function proxy execution part 236, and a subsequent function result transmission part 237.

Subsequent function necessity determination part 235 and subsequent function proxy execution part 236 constitute a function group (enclosed by dashed line y in FIG. 1) of determining the presence or absence of a function to be autonomously executed by the server. Furthermore, reception content determination-storage part 135 of client 100 and function response information transmission part 234 of server 200 constitute a function group (enclosed by dashed line z in FIG. 1) of notifying the client of the results of autonomous executions in the server.

### <Function Call Information Receiver-Parser Part 231>

Function call information receiver-parser part 231 extracts function call information indicative of a function name and an argument(s) from the data received from the client side.

Function call information receiver-parser part 231 checks for data arrival at NIC 211 by polling, and when data has arrived, performs reception processing and parsing and calls function proxy caller part 232. An example of the data format conforms to function call information packetization-transmission part 134 (see the data format in FIG. 2).

Function call information receiver-parser part 231 receives a “reception packet” from NIC 211 as an input, and as an output, notifies function proxy caller part 232 of the “function name-argument”.

Note that the method of detecting packet arrivals may involve detection by an interrupt instead of polling.

In addition, when function call information packetization-transmission part 134 has a function of dividing into a plurality of packets, function call information receiver-parser part 231 may have a function for combining.

### <Function Proxy Caller Part 232>

Function proxy caller part 232 instructs function execution part 233 to execute a function based on the “function name-argument” received from function call information receiver-parser part 231, and notifies subsequent function necessity determination part 235 to determine whether to trigger an execution of a subsequent function.

Function proxy caller part 232 receives the “function name-argument” from function call information receiver-parser part 231 as an input, and passes the “function name-argument” to function execution part 233. At this time, the “function name-argument” is also passed to subsequent function necessity determination part 235 at the same time.

### <Function Execution Part 233>

Function execution part 233 is a functional part that executes a designated function, and is an existing API runtime (for example, OpenCL runtime or BBDEV API runtime).

Function execution part 233 receives a “function information-argument” from function proxy caller part 232 as an input, and passes the “function name” and the “function execution result” to function response information transmission part 234 as an output.

Function execution part 233 may operate an accelerator such as a field programmable gate array (FPGA)/graphics processing unit (GPU) as hardware.

### <Function Response Information Transmission Part 234>

Function response information transmission part 234 serializes the “function name” and the “execution result of the function” received from subsequent function result transmission part 237 or function execution part 233 into the form of a packet(s) and notifies NIC 211 of them, to transmit them to client 100 via NW 1.

Function response information transmission part 234 receives a notification of the “function name” and the “execution result of the function” from subsequent function result transmission part 237 or function execution part 233 as an input. Function response information transmission part 234 notifies NIC 211 of the “function name” and the “execution result of the function” as an output.

### <Subsequent Function Necessity Determination Part 235>

Subsequent function necessity determination part 235 determines whether a callee function (enqueue function) is present in the function name and argument(s) received from function call information receiver-parser part 231.

Subsequent function necessity determination part 235 compares the “function name-argument” received from function proxy caller part 232 with a “list of functions entailing a subsequent function” held by the present functional part to determine whether there is a subsequent function corresponding to the function name. The “list of functions entailing a subsequent function” held by subsequent function necessity determination part 235 is similar to the “list of functions entailing a subsequent function” held by subsequent function determination part 133. When a subsequent function is present, subsequent function necessity determination part 235 notifies subsequent function proxy execution part 236 of the subsequent function name, and when no subsequent function is present, performs no processing.

Subsequent function necessity determination part 235 receives the “function name-argument” from function proxy caller part 232 as an input, and notifies subsequent function proxy execution part 236 of a “subsequent function name-argument” as an output.

### <Subsequent Function Proxy Execution Part 236>

When subsequent function necessity determination part 235 determines that a callee function (enqueue function) is present, subsequent function proxy execution part 236 instructs function execution part 233 to perform proxy execution of a subsequent function (dequeue function) corresponding to the callee function (enqueue function).

Subsequent function proxy execution part 236, based on the “subsequent function name-argument” received from subsequent function necessity determination part 235, instructs function execution part 233 to call the subsequent function. When the execution of the subsequent function is successful and a “function execution result” is obtained, subsequent function proxy execution part 236 notifies subsequent function result transmission part 237 of the “execution result of the subsequent function”. When the execution of the subsequent function has failed, subsequent function proxy execution part 236 repeats the instruction to function execution part 233.

Here, the determination of the success after the execution of the function may be performed by checking the content of the execution result of the function in addition to checking the error code of the execution result of the function. For example, for a dequeue function that extracts a processing result of a queue, it is conceivable that “the number of processing result is zero and there is no error code” is not regarded as completion, and the finish condition is the number of processing result being one or more, and “the number of processing result is zero or more and a dequeue function” is set.

Note that the detection of the completion of execution of the function may be performed not only by repeatedly executing the function by polling but also by a method of detecting the completion of the result by an interrupt. At this time, when the caller makes a polling type call, the function call may be performed replacing the polling type call with an interrupt-type notification, or may be in the opposite form.

Subsequent function proxy execution part 236 receives the “subsequent function name-argument” from subsequent function necessity determination part 235 as an input.

Subsequent function proxy execution part 236, as an output 1, transmits the “subsequent function name-argument” to function execution part 233 to perform a function call. Subsequent function proxy execution part 236, as an output 2, when the execution of the subsequent function is successful, notifies subsequent function result transmission part 237 of the “execution result of the subsequent function”.

### <Subsequent Function Result Transmission Part 237>

Subsequent function result transmission part 237 notifies function response information transmission part 234 of the “execution result of the subsequent function” received from subsequent function proxy execution part 236.

Subsequent function result transmission part 237 receives, as inputs, the “function name” and the “execution result of the subsequent function” from subsequent function proxy execution part 236, and as outputs, notifies function response information transmission part 234 of the “function name” and the “execution result of the subsequent function”.

Hereinbelow, description will be given of an operation of arithmetic processing offload system 1000 configured as described above.

### [Outline of Operation of Arithmetic Processing Offload System 1000]

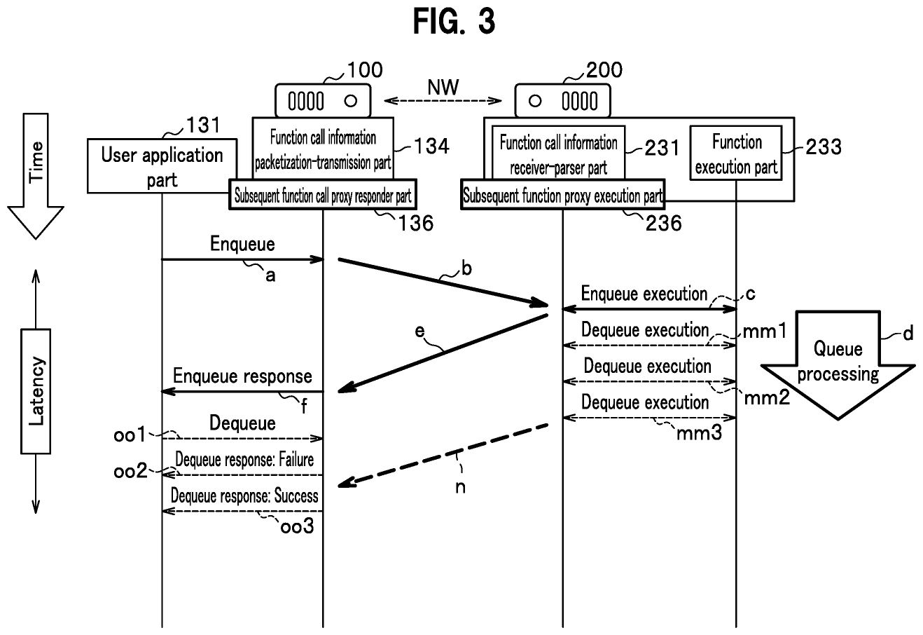

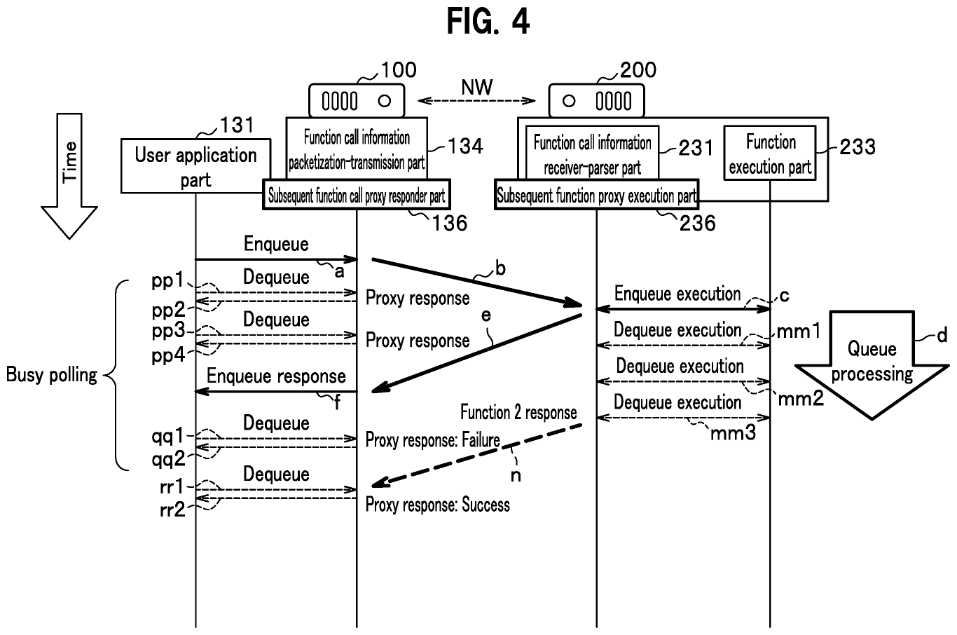

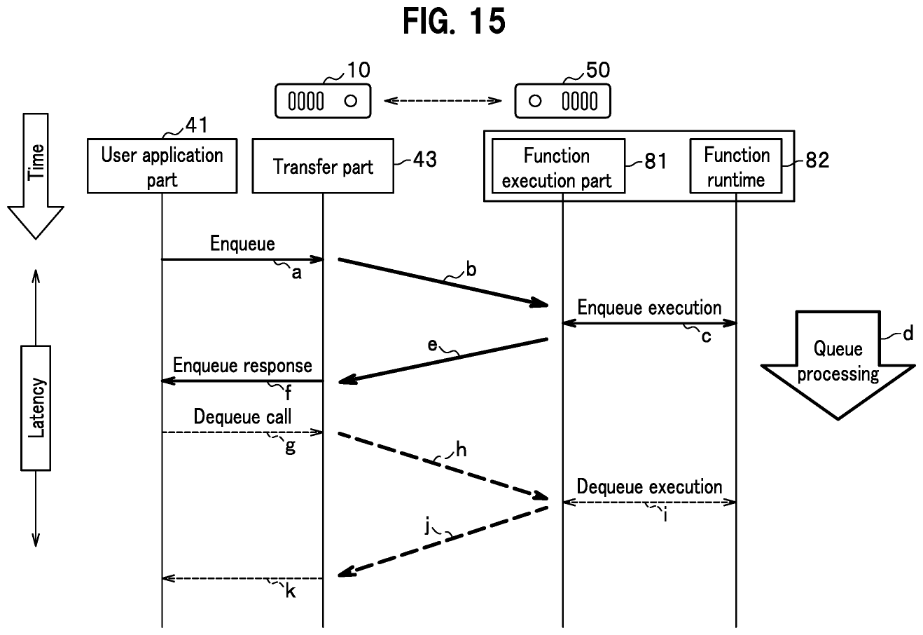

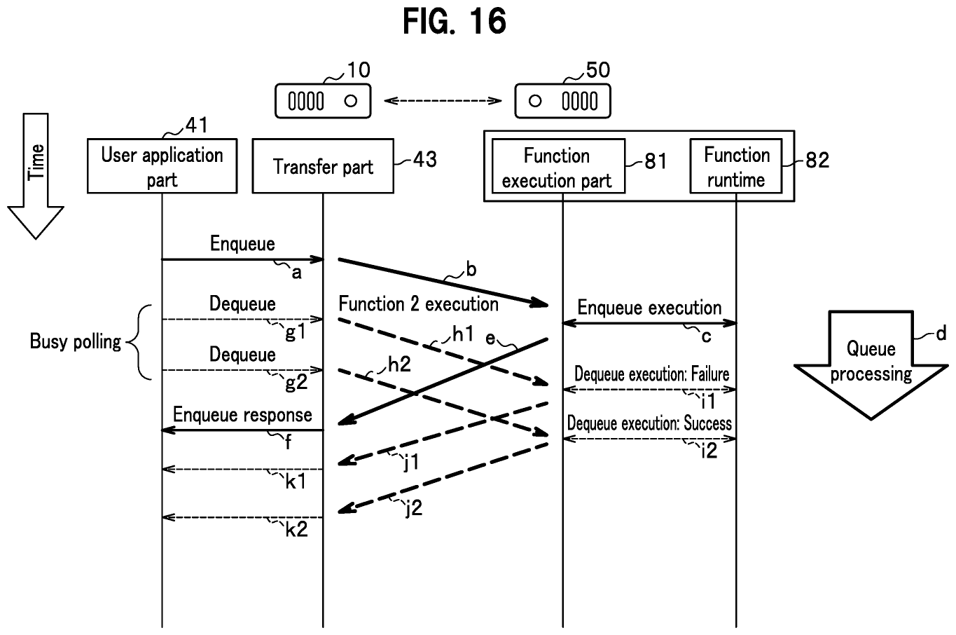

With reference to FIGS. 3 and 4, a control sequence of arithmetic processing offload system 1000 will be described. In the description of FIGS. 3 and 4, the same control sequences as those in FIGS. 15 and 16 are denoted by the same reference signs.

<Pattern 1>: Case of calling a plurality of functions synchronously

FIG. 3 is a diagram illustrating a control sequence <Pattern 1> in a case where a plurality of functions are called synchronously between client 100 and server 200 of arithmetic processing offload system 1000 illustrated in FIG. 1.

Client 100 includes user application part 131, function call information packetization-transmission part 134, and subsequent function call proxy responder part 136. Server 200 includes function call information receiver-parser part 231, function execution part 233 (corresponding to function runtime 82 in FIG. 15), and subsequent function proxy execution part 236.

User application part 131 of client 100 calls (reference sign a in FIG. 3) an enqueue function. Function call information packetization-transmission part 134 transfers (reference sign b in FIG. 3) the enqueue function to server 200 via the NW (NW 1 in FIG. 1).

Function call information receiver-parser part 231 of server 200 executes (reference sign c in FIG. 3) the enqueue function with function execution part 233 (function runtime). Then, function execution part 233 executes queue processing (reference sign d in FIG. 3).

Point 1: Completion of execution of subsequent function within server 200

In the example illustrated in FIG. 3, function call information receiver-parser part 231 executes (reference sign c in FIG. 3) an enqueue function with function execution part 233. In the present invention, when subsequent function necessity determination part 235 (FIG. 1) determines that an enqueue function (callee function) is present, subsequent function proxy execution part 236 instructs function execution part 233 to perform proxy execution of a dequeue function (subsequent function) corresponding to the enqueue function. Subsequent function proxy execution part 236 executes (reference signs mm1, mm2, and mm3 in FIG. 3) the dequeue function processing with function execution part 233. That is, subsequent function proxy execution part 236 of server 200, upon detection of the enqueue function, instructs function execution part 233 to perform proxy execution of the dequeue function corresponding to the enqueue function by busy polling within server 200. Other than the busy polling, it is also possible to perform the detection in the form of an interrupt.

As execution of the dequeue function is completed within the server, it is possible to reduce the number of functions to be called via the NW and minimize the number of times of function calls via the NW, thereby to achieve low latency.

Server 200 transmits (reference sign e in FIG. 3) the enqueue function execution result to function call information packetization-transmission part 134 of client 100 via the NW.

Function call information packetization-transmission part 134 of client 100 passes (reference sign f in FIG. 3) the enqueue function execution result received from server 200 to user application part 131 as an enqueue function response.

Point 2: Subsequent function proxy response within client 100

In the present invention, subsequent function call proxy responder part 136 (FIG. 1), upon reception of a notification of the enqueue function response, performs, for a dequeue function called by user application part 131, a response of the dequeue function as a proxy of the server 200 side. That is, subsequent function call proxy responder part 136 of client 100 responds, inside client 100, to the dequeue function calls from user application part 131 as a proxy, until the notification of the result from server 200 is made. In the example illustrated in FIG. 3, subsequent function call proxy responder part 136, upon reception (reference sign oo1 in FIG. 3) of a dequeue function call from user application part 131, responds inside client 100 to the dequeue function call with a response: failure (reference sign 002 in FIG. 3) as a proxy.

As the proxy response is performed inside the client for dequeue function calls until the notification of the result is made from the server (as the response is completed within the client until an execution result is received from the server), it is possible to reduce the number of times of function calls via the NW. As it is not necessary to change user application part 131, the transparency of Requirement 1 is achieved.

As described as Point 1 above, subsequent function proxy execution part 236 of server 200, upon detection of an enqueue function, executes (reference signs mm1, mm2, and mm3 FIG. 3) the dequeue function by busy polling with function runtime 82. This dequeue function execution is dequeue function processing that completes within server 200.

Function call information receiver-parser part 231 of server 200 transmits (reference sign n in FIG. 3) the dequeue function execution result to subsequent function call proxy responder part 136 of client 100.

Subsequent function call proxy responder part 136 receives (reference sign n in FIG. 3) the dequeue function execution result notification from server 200, and responds to user application part 131 with a dequeue function response: success (reference sign 003 in FIG. 3).

As described above, in server 200, when subsequent function necessity determination part 235 detects an enqueue function, subsequent function proxy execution part 236 executes (reference signs mm1, mm2, and mm3 in FIG. 3) dequeue function processing within server 200. On the other hand, in client 100, subsequent function call proxy responder part 136 performs (reference sign 002 in FIG. 3) proxy responses to dequeue function calls from user application part 131 inside client 100, and when having received (reference sign n in FIG. 3) the dequeue function execution result notification from server 200, finishes the proxy responses and responds to user application part 131 with a dequeue function response: success (reference sign 003 in FIG. 3).

Server 200 completes execution of the dequeue function processing within server 200. With this, it is possible to reduce the number of functions to be called via the NW, reduce the number of times of function calls via the NW, to achieve low latency. In the example illustrated in FIG. 3, NW communication is reduced from four times (FIG. 15) to three times, and low latency and resource saving are achieved.

Client 100 completes the proxy response to the dequeue function calls from user application part 131 inside client 100 until the reception of the dequeue function execution result from server 200. With this, there is an effect that the function interfaces are maintained, that there is no need to change the client app, and that there is no need to change the interface operated by the client application.

### <Pattern 2>: Case of Calling a Plurality of Functions Asynchronously

FIG. 4 is a diagram illustrating a control sequence <Pattern 2> in a case where a plurality of functions are called asynchronously between client 100 and server 200 of arithmetic processing offload system 1000 illustrated in FIG. 1.

User application part 131 of client 100 executes (reference sign a in FIG. 4) an enqueue function.

Subsequent function call proxy responder part 136 of client 100 performs a proxy responses inside client 100 to dequeue function calls from user application part 131 until the result notification from server 200. In the example of FIG. 4, subsequent function call proxy responder part 136 performs a proxy response (reference sign pp2 in FIG. 4) to a dequeue function call (reference sign pp1 in FIG. 4) from user application part 131 and performs a proxy response (reference sign pp4 in FIG. 4) to a dequeue function call (reference sign pp3 in FIG. 4). Similarly, a proxy response (reference sign qq2 in FIG. 4) is performed to a dequeue function call (reference sign qq1 in FIG. 4) from user application part 131, and a proxy response (reference sign rr2 in FIG. 4) is performed to a dequeue function call (reference sign rr1 in FIG. 4).

As subsequent function call proxy responder part 136 has received the result notification from server 200 before the dequeue function call (reference sign rr1 in FIG. 4), the proxy response is success (reference sign rr2 in FIG. 4). Incidentally, the proxy response to the dequeue function call (reference sign qq1 in FIG. 4) before receiving the result notification from server 200 is failure (reference sign qq2 in FIG. 4).

On the other hand, function call information receiver-parser part 231 of server 200 executes (reference sign c in FIG. 4) the enqueue function with function runtime 82 and executes (reference signs mm1, mm2, and mm3 in FIG. 4) dequeue function processing.

Server 200 transmits (reference sign e in FIG. 4) the enqueue function execution result to function call information packetization-transmission part 134 of client 100.

Function call information packetization-transmission part 134 of client 100 passes (reference sign f in FIG. 4) the enqueue function execution result received from server 200 to user application part 131 as the enqueue function response.

Function call information receiver-parser part 231 of server 200 transmits (reference sign n in FIG. 4) the dequeue function execution result to subsequent function call proxy responder part 136 of client 100.

Subsequent function call proxy responder part 136 receives (reference sign n in FIG. 4) the dequeue function execution result notification from server 200, and responds to user application part 131 with a dequeue function response: success (reference sign rr2 in FIG. 4).

As described above, in the pattern of an asynchronous call, resource saving is achieved due to the reduction of the number of times of function calls via the NW. In the example illustrated in FIG. 4, NW communication is reduced from 6 times (FIG. 16) to 3 times, achieving resource saving.

### [Operation of Arithmetic Processing Offload System]

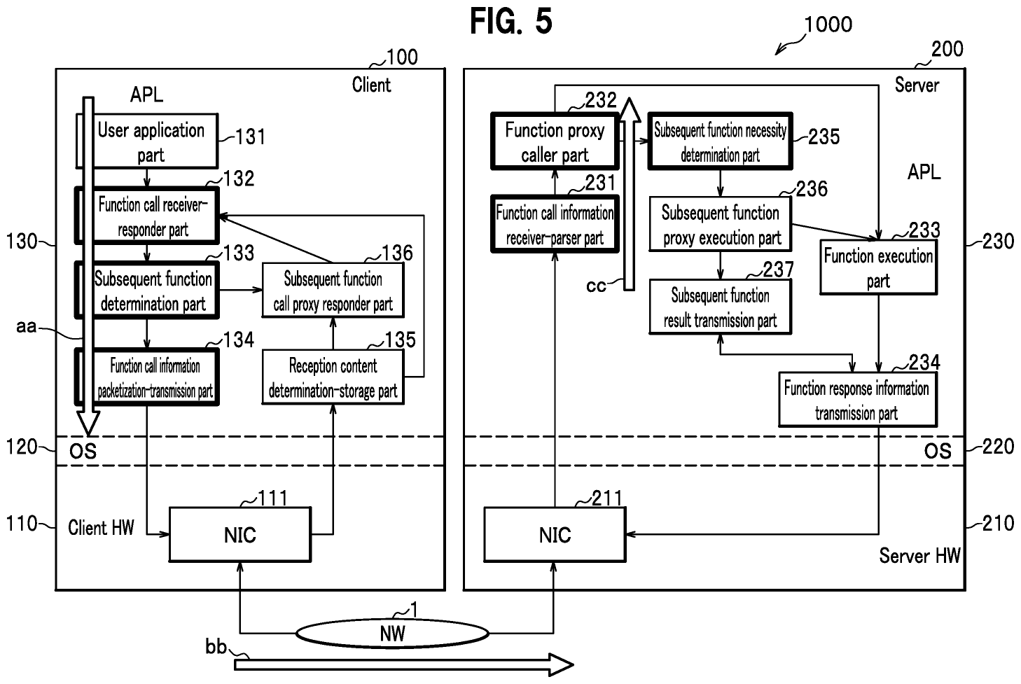

With reference to FIGS. 5 to 8, description will be given of operation steps of the arithmetic processing offload system. The same components as those in FIG. 1 are denoted by the same reference signs as those in FIG. 1. In addition, functional parts in an active state are indicated by thick frames.

### <Step 1>: “Execution of Enqueue Function”

FIG. 5 is an operation explanatory diagram illustrating “execution of an enqueue function” of the arithmetic processing offload system.

Client 100 executes (reference sign aa in FIG. 5) the enqueue function, reaching (reference sign cc in FIG. 5) the proxy execution part (function call information receiver-parser part 231, function proxy caller part 232, and subsequent function necessity determination part 235) on the server 200 side via NW 1 (reference sign bb in FIG. 5).

Specifically, the execution of the enqueue function is operated as follows. Function call receiver-responder part 132 of client 100 receives a “function name-argument” from user application part 131 and passes the “function name-argument” to subsequent function determination part 133. Subsequent function determination part 133 receives the “function name-argument” from function call receiver-responder part 132 and passes the “function name-argument” to function call information packetization-transmission part 134. Subsequent function determination part 133 receives the “function name-argument” from function call receiver-responder part 132. Function call information packetization-transmission part 134 serializes the input function name and multiple arguments according to a predetermined format into a single piece of data. In <Reception Pattern>, NIC 111 receives “reception data” from function call information packetization-transmission part 134 as an input and transmits the reception data to the server 200 side via NW 1.

On the server 200 side, subsequent function necessity determination part 235 determines that it is “necessary”.

### <Step 2>: “Response of Enqueue Function”

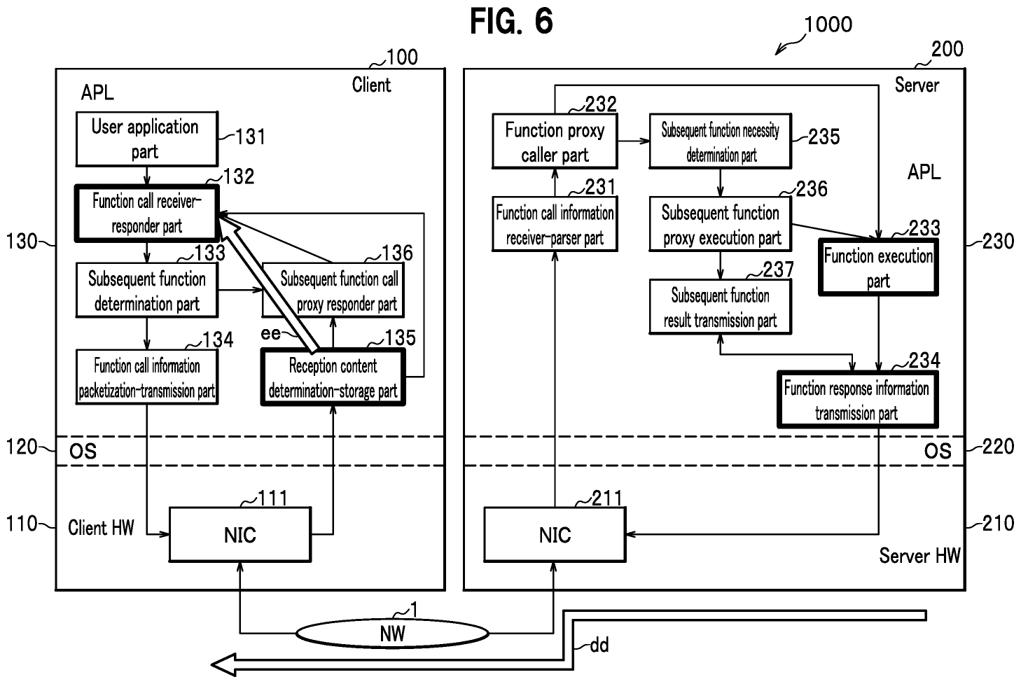

FIG. 6 is an operation explanatory diagram illustrating the “response of an enqueue function” of the arithmetic processing offload system.

Server 200 responds (reference sign dd in FIG. 6) to client 100 with the result of the enqueue function via NW 1.

Specifically, the result response of the enqueue function is specifically operated as follows. Function execution part 233 receives the “function information-argument” from function proxy caller part 232 and passes the “function name” and the “function execution result” to function response information transmission part 234. Function response information transmission part 234 serializes the “function name” and the “execution result of the function” received from function execution part 233 into the form of a packet and notifies NIC 211 of them, to transmit them to client 100 via NW 1.

Client 100 receives the result and responds to the client app. Specifically, reception content determination-storage part 135 receives packet data from NIC 111. Here, reception content determination-storage part 135 determines that the type of the function is not “subsequent function” and responds (reference sign ee in FIG. 6) to function call receiver-responder part 132 with the “function execution result”. Function call receiver-responder part 132 receives the “execution result of the function” from reception content determination-storage part 135 and responds to user application part 131 with the “execution result of the function”.

### <Step 3>: “Automatic Execution of Dequeue Function”

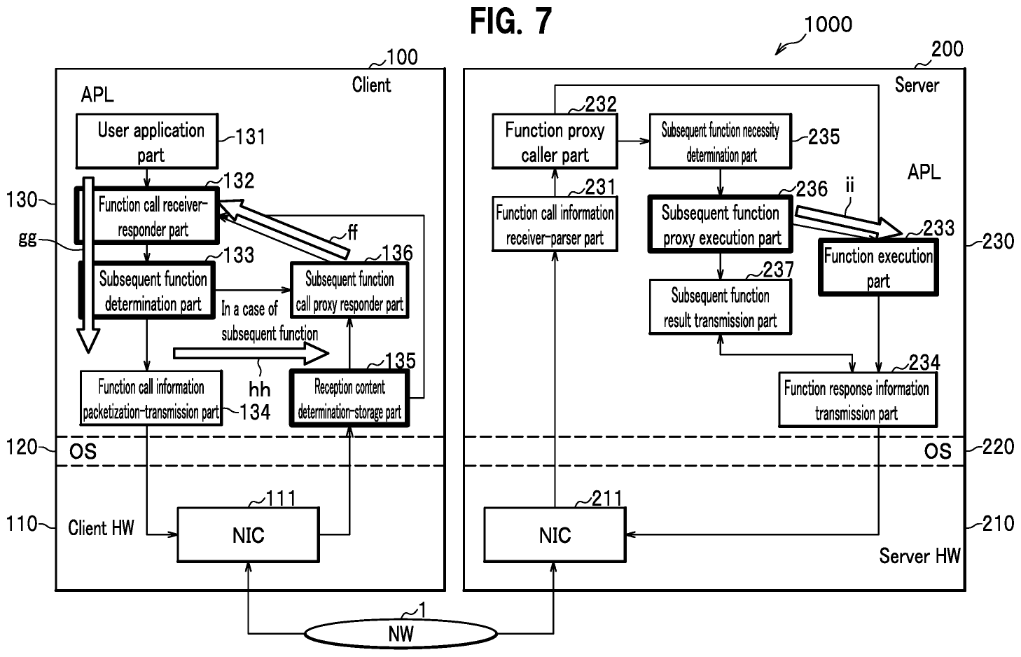

FIG. 7 is an operation explanatory diagram illustrating “automatic execution of a dequeue function” of the arithmetic processing offload system.

In client 100, for execution of a subsequent function (dequeue function), a proxy response by subsequent function call proxy responder part 136 is performed until reception content determination-storage part 135 receives the result from server 200.

The execution of the subsequent function (dequeue function) is specifically operated as follows.

In a case where the type of the function is “subsequent function”, reception content determination-storage part 135 responds to subsequent function call proxy responder part 136 with a “function execution result”. Subsequent function call proxy responder part 136 references the “function execution result” held by reception content determination-storage part 135 based on the input “function name-argument” to complete a result response of the function within the client. Subsequent function call proxy responder part 136, based on the “execution result of the function” acquired from reception content determination-storage part 135, responds (reference sign ff in FIG. 7) to function call receiver-responder part 132, the caller, with the execution result of the function. The “function name-argument” is passed. Function call receiver-responder part 132 receives (reference sign ff in FIG. 7) the “execution result of the function” from reception content determination-storage part 135 and responds to user application part 131 with the “execution result of the function”. Subsequent function determination part 133 determines, based on the input function name, whether the input function name matches a subsequent function, and according to the determination result, select whether to execute a function call via the network (function call information packetization-transmission part 134) or a local function call (subsequent function call proxy responder part 136). The present case is of a subsequent function and subsequent function determination part 133 passes (reference sign hh in FIG. 7) the “function name-argument” to subsequent function call proxy responder part 136.

In server 200, subsequent function proxy execution part 236 continues executing (reference sign ii in FIG. 7) the dequeue function as a proxy: Subsequent function proxy execution part 236 sends the “subsequent function name-argument” to function execution part 233 to call the function. Function execution part 233 executes the designated function. Here, subsequent function proxy execution part 236 continues executing the dequeue function as a proxy with function execution part 233.

### <Step 4>: “Completion of Dequeue Function”

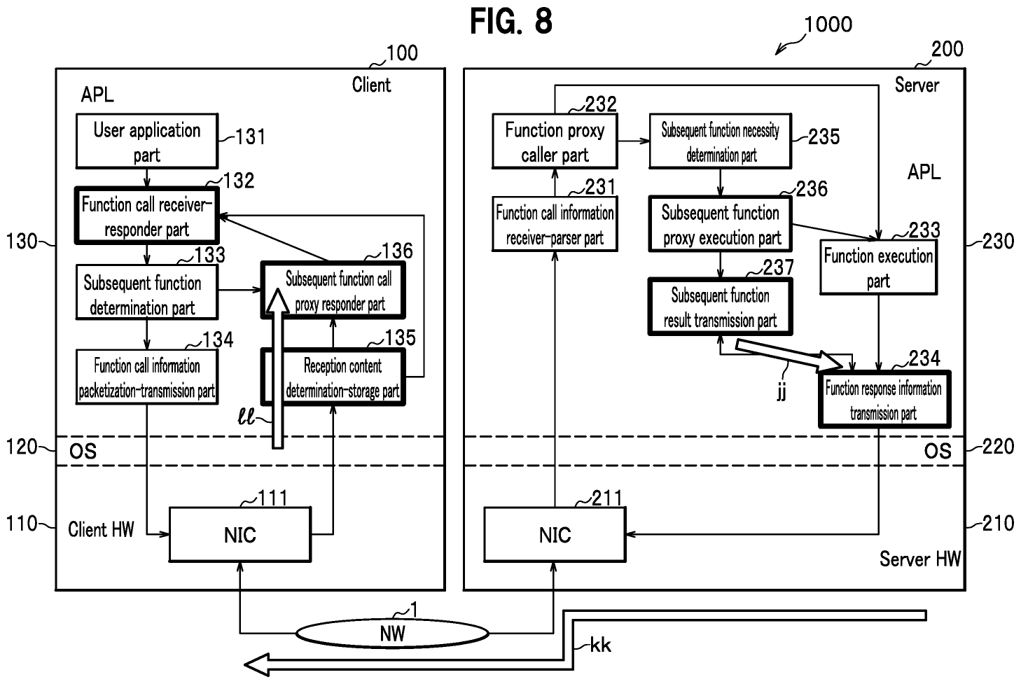

FIG. 8 is an operation explanatory diagram illustrating “completion of a dequeue function” of the arithmetic processing offload system.

When subsequent function proxy execution part 236 succeeds in the dequeue function processing, server 200 transmits the operation result to client 100.

The success in the dequeue function processing is specifically operated as follows. When the execution of the subsequent function is successful, subsequent function proxy execution part 236 notifies subsequent function result transmission part 237 of an “execution result of the subsequent function”. Subsequent function result transmission part 237 notifies (reference sign jj in FIG. 8) function response information transmission part 234 of the “execution result of the subsequent function” received from subsequent function proxy execution part 236. Function response information transmission part 234 receives the notification of the “function name” and “execution result of the function” from subsequent function result transmission part 237. Function response information transmission part 234 notifies (reference sign kk in FIG. 8) client 100 of the “function name” and “execution result of the function” via NIC 211.

Client 100 stores the operation result received from server 200 in reception content determination-storage part 135. Reception content determination-storage part 135 responds (reference sign l1 in FIG. 8) to inquiries from subsequent function call proxy responder part 136 with the result. Subsequent function call proxy responder part 136 responds to user application part 131 with the result via function call receiver-responder part 132.

### [Offload Processing of Arithmetic Processing Offload System 1000]

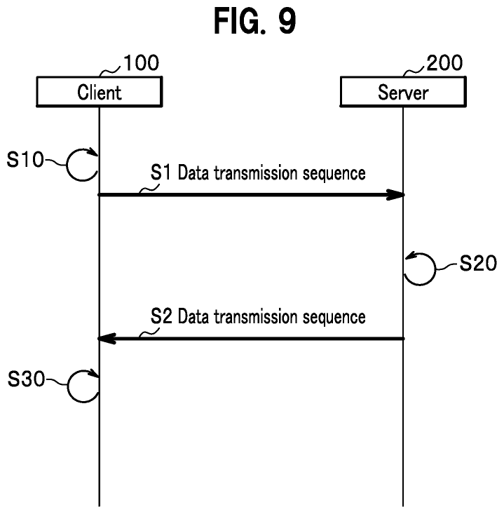

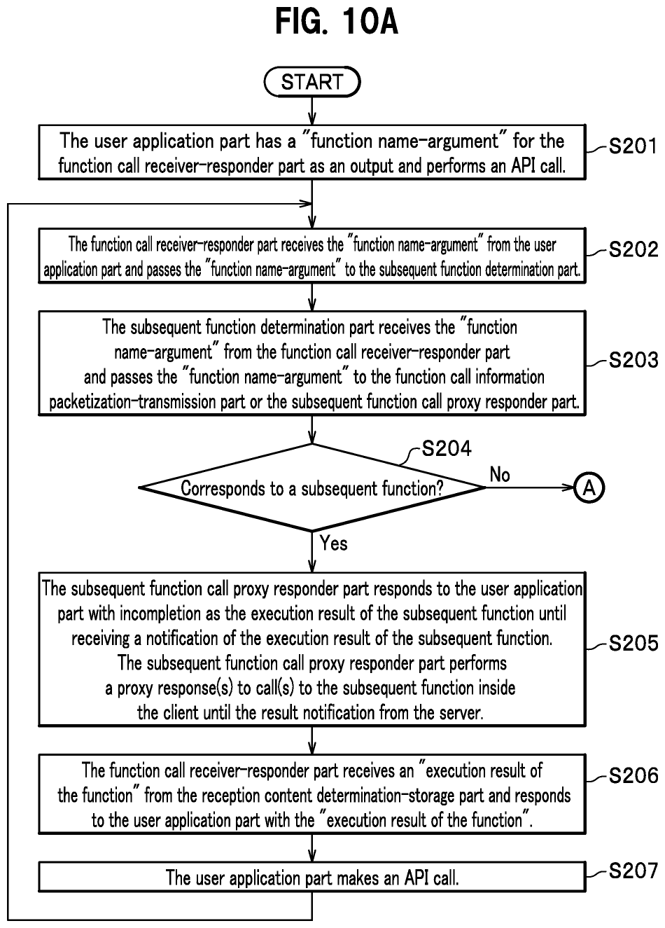

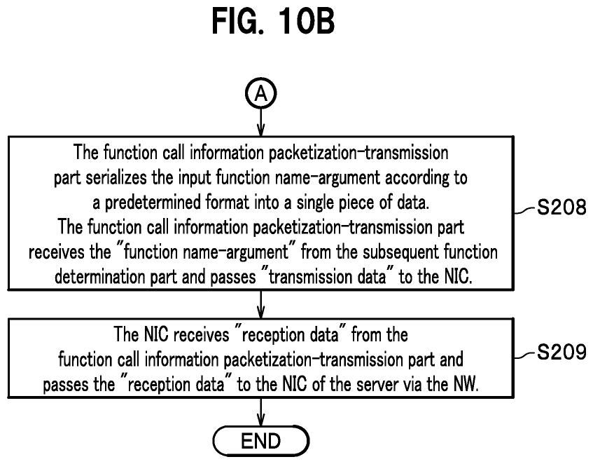

Next, description will be given of offload processing of arithmetic processing offload system 1000 with reference to the control sequence of FIG. 9 and the flowcharts of FIGS. 10A to 12.

FIG. 9 is a control sequence illustrating offload processing of arithmetic processing offload system 1000 in FIG. 1.

As illustrated in FIG. 9, client 100 (FIG. 1) performs transmission-time offload processing (S10: see FIGS. 10A and 10B) and transmits (S1: see data transmission sequence) data of the processing result to server 200 (FIG. 1) via NW 1 (FIG. 1).

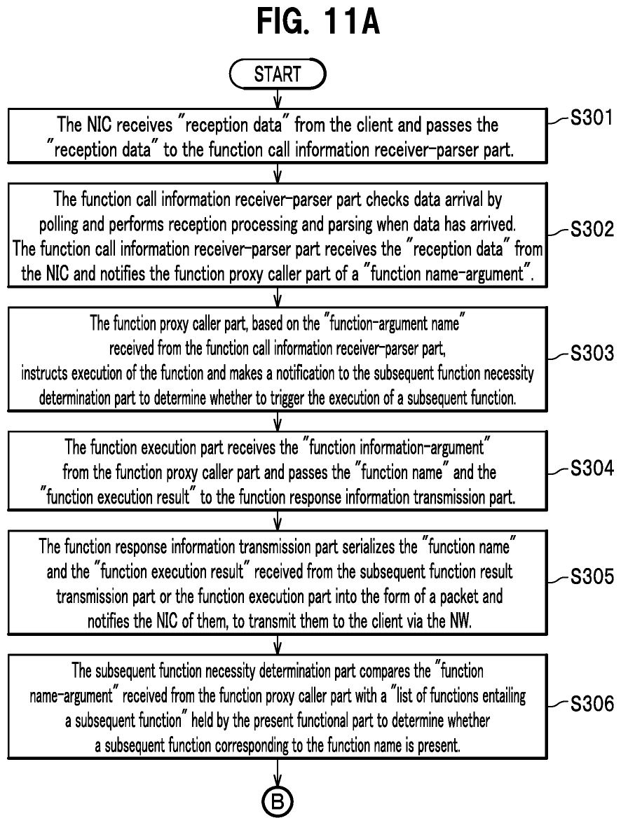

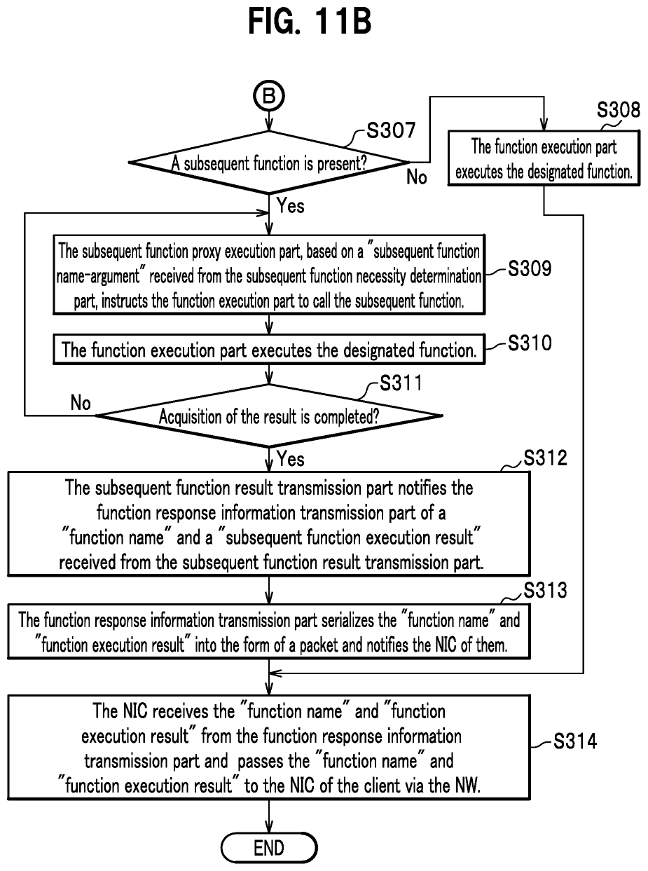

Server 200 receives the data transmitted from client 100 via NW 1 and executes offload processing in server 200 (S20; FIGS. 11A and 11B).

Server 200 transmits (S2: see data transmission sequence) data of the function processing result to client 100 via NW 1.

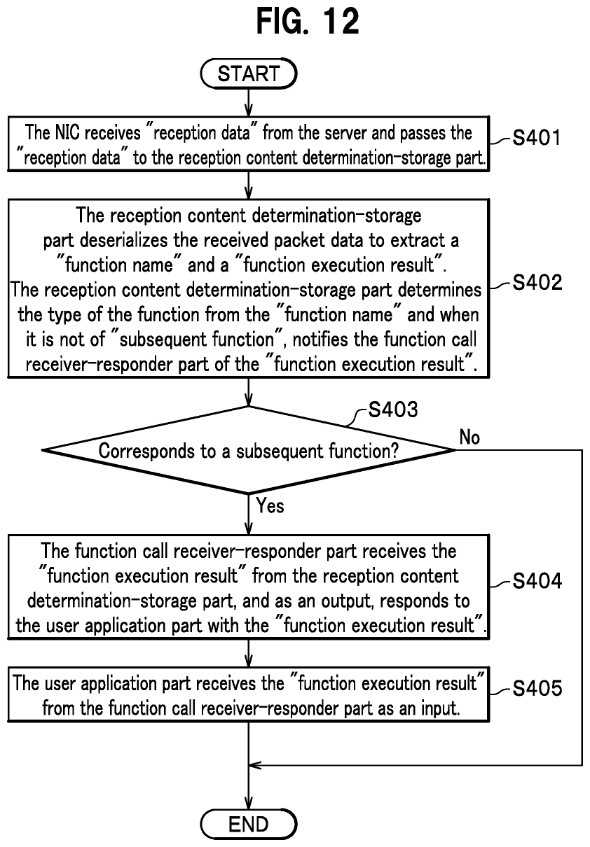

Client 100 performs reception-time offload processing (S30: FIG. 12).

FIGS. 10A and 10B are flowcharts illustrating the transmission-time offload processing (processing of S10 in FIG. 9) by client 100 of arithmetic processing offload system 1000 in FIG. 1.

In step S201, user application part 131 has a “function name-argument” for function call receiver-responder part 132 as an output and performs an API call.

In step S202, function call receiver-responder part 132 receives the “function name-argument” from user application part 131 and passes the “function name-argument” to subsequent function determination part 133.

In step S203, subsequent function determination part 133 receives the “function name-argument” from function call receiver-responder part 132 and passes the “function name-argument” to function call information packetization-transmission part 134 or subsequent function call proxy responder part 136.

In step S204, subsequent function determination part 133 determines whether correspondence to a subsequent function is present. Subsequent function determination part 133 compares the input function name with a “list of functions entailing a subsequent function” to determine whether the input function name matches a subsequent function.

In a case where correspondence to a subsequent function is present (S204: Yes), in step S205, subsequent function call proxy responder part 136 responds to user application part 131 with incompletion as the execution result of the subsequent function until receiving a notification of the execution result of the subsequent function. Subsequent function call proxy responder part 136 performs a proxy response(s) to the call(s) to the subsequent function (completes the response(s) within the client until reception of an execution result from the server), inside the client until the result notification from server 200.

In step S206, function call receiver-responder part 132 receives the “execution result of the function” from reception content determination-storage part 135 and responds to user application part 131 with the “execution result of the function”.

In step S207, user application part 131 makes an API call and returns to step S202.

When correspondence to a subsequent function is not present in step S204 (S204: No), the process proceeds to step S208 of FIG. 10B.

In step S208, function call information packetization-transmission part 134 serializes the input function name and multiple arguments according to a predetermined format into a single piece of data. Function call information packetization-transmission part 134 receives the “function name-argument” from subsequent function determination part 133 and passes the “transmission data” to NIC 111.

In step S209, NIC 111 receives “reception data” from function call information packetization-transmission part 134, transmits a packet to server 200 connected via NW 1, and finishes the processing of this flow:

FIGS. 11A and 11B are flowcharts illustrating offload processing (processing of S20 in FIG. 9) of server 200 of arithmetic processing offload system 1000 in FIG. 1.

In step S301, NIC 211 receives “reception data” from the client and passes the “reception data” to function call information receiver-parser part 231.

In step S302, function call information receiver-parser part 231 checks data arrival to NIC 211 by polling and performs reception processing and parsing when data has arrived. Function call information receiver-parser part 231 receives the “reception data” from NIC 211 and notifies function proxy caller part 232 of a “function name-argument”.

In step S303, based on the “function name-argument” received from function call information receiver-parser part 231, function execution by function execution part 233 is instructed and a notification is made to subsequent function necessity determination part 235 in order to determine whether to trigger an execution of a subsequent function.

In step S304, function execution part 233 receives the “function information-argument” from function proxy caller part 232 and passes the “function name” and the “function execution result” to function response information transmission part 234.

In step S305, function response information transmission part 234 serializes the “function name” and the “execution result of the function” received from subsequent function result transmission part 237 or function execution part 233 into the form of a packet and notifies NIC 211 of them, to transmit them to client 100 via NW 1.

In step S306, subsequent function necessity determination part 235 compares the “function name-argument” received from function proxy caller part 232 with a “list of functions entailing a subsequent function” held by the present functional part to determine whether a subsequent function corresponding to the function name is present. When a subsequent function is present, subsequent function necessity determination part 235 notifies subsequent function proxy execution part 236 of the subsequent function name.

In step S307, in subsequent function necessity determination part 235, when no subsequent function corresponding to the function name is present (S307: No), in step S308, function execution part 233 executes the designated function and proceeds to step S314.

When a subsequent function corresponding to the function name is present (S307: Yes), in step S309, subsequent function proxy execution part 236, based on the “subsequent function name-argument” received from subsequent function necessity determination part 235, instructs function execution part 233 to call the subsequent function. When the execution of the subsequent function is successful and a “function execution result” is obtained, subsequent function proxy execution part 236 notifies subsequent function result transmission part 237 of the “subsequent function execution result”. When the execution of the subsequent function has failed, subsequent function proxy execution part 236 repeats the instruction to function execution part 233 (processes the following S309 to S311 in a loop).

In step S310, function execution part 233 executes the designated function.

In step S311, subsequent function proxy execution part 236 determines whether acquisition of the result is completed, and when acquisition of the result is not completed (S311: No), the process returns to step S309.

When acquisition of the result is completed (S311: Yes), in step S312, subsequent function result transmission part 237 receives the “function name” and “subsequent function execution result” from subsequent function proxy execution part 236 and notifies function response information transmission part 234 of the “function name” and the “subsequent function execution result”

In step S313, function response information transmission part 234 serializes the “function name” and “function execution result” received from subsequent function result transmission part 237 or function execution part 233 into the form of a packet and notifies NIC 211 of them.

In step S314, NIC 211 receives the “function name” and “function execution result” from function response information transmission part 234, passes the “function name” and “function execution result” to NIC 211 of client 100 via NW 1, and finishes the processing of this flow.

FIG. 12 is a flowchart illustrating reception-time offload processing (processing in S30 illustrated in FIG. 9) by client 100 of arithmetic processing offload system 1000 in FIG. 1.

In step S401, NIC 111 of client 100 receives “reception data” from server 200 connected via NW 1 and passes the “reception data” to reception content determination-storage part 135.

In step S402, reception content determination-storage part 135 deserializes the received packet data to extract a “function name” and a “function execution result”. Reception content determination-storage part 135 determines the type of the function from the “function name” and when it is not of “subsequent function”, notifies function call receiver-responder part 132 of the “function execution result”.

In step S403, subsequent function determination part 133 determines whether correspondence to a subsequent function is present. When correspondence to a subsequent function is not present (S403: No), the processing of this flow is finished.

In a case where correspondence to a subsequent function is present (S403: Yes), in step S404, function call receiver-responder part 132 receives the “function execution result” from reception content determination-storage part 135, and as an output, responds to user application part 131 with the “function execution result”.

In step S405, user application part 131 receives the “function execution result” from function call receiver-responder part 132 as an input, and finishes the processing of this flow.

### [Hardware Configuration]

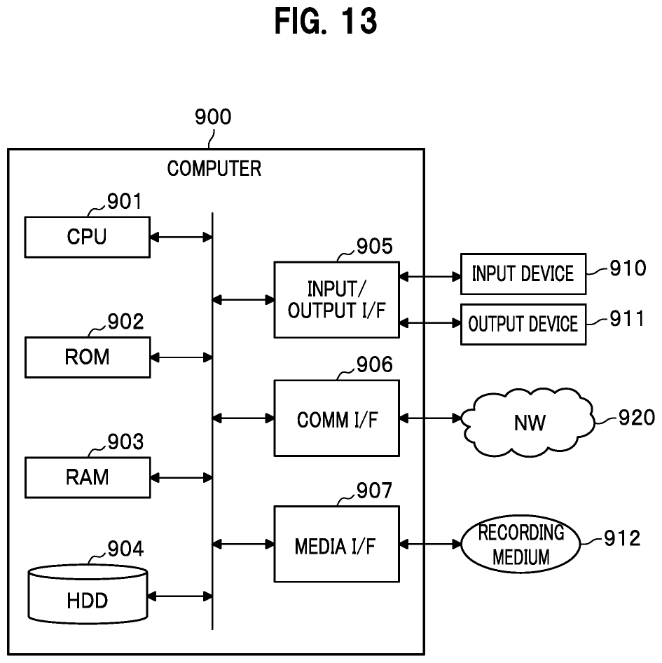

Client 100 or server 200 of arithmetic processing offload system 1000 according to the present embodiment is implemented by, for example, a computer 900 having the configuration as illustrated in FIG. 13.

FIG. 13 is a hardware configuration diagram illustrating an example of computer 900 that implements the functional parts of client 100.

Computer 900 includes a CPU 901, a ROM 902, a RAM 903, an HDD 904, a communication interface (I/F) 906, an input/output interface (I/F) 905, and a media interface (I/F) 907.

CPU 901 operates according to the program stored in ROM 902 or HDD 904 and controls each part of client 100 illustrated in FIG. 1. ROM 902 stores a boot program to be executed by CPU 901 when computer 900 starts, a program depending on the hardware of computer 900, and the like.

CPU 901 controls an input device 910, such as a mouse or a keyboard, and an output device 911, such as a display, via input/output I/F 905. CPU 901 acquires data from input device 910 and outputs generated data to the output device 911 via input/output I/F 905. Note that a graphics processing unit (GPU) or the like may be used as a processor in conjunction with CPU 901.

HDD 904 stores a program to be executed by CPU 901, data to be used by the program, and the like. Communication I/F 906 receives data from another device via a communication network (for example, network (NW) 920), outputs the data to CPU 901, and transmits data generated by CPU 901 to another device via the communication network.

Media I/F 907 reads a program or data stored in a recording medium 912, and outputs the program or data to CPU 901 via RAM 903. CPU 901 loads a program related to target processing from recording medium 912 into RAM 903 via media I/F 907 and executes the loaded program. Recording medium 912 is an optical recording medium such as a digital versatile disc (DVD) or a phase change rewritable disk (PD), a magneto-optical recording medium such as a magneto optical disk (MO), a magnetic recording medium, a conductor memory tape medium, a semiconductor memory, or the like.

For example, when computer 900 functions as client 100 configured as a device according to the present embodiment, CPU 901 of computer 900 implements the functional parts of client 100 by executing a program loaded on RAM 903. In addition, HDD 904 stores data in RAM 903. CPU 901 reads the program related to the target processing from recording medium 912 and executes the program. Additionally, CPU 901 may read the program related to the target processing from other devices via the communication network (NW 920).

Although client 100 of arithmetic processing offload system 1000 according to the present embodiment has been described above, server 200 can also be implemented by computer 900 having a similar configuration.

### Effects

As described above, arithmetic processing offload system 1000 includes client 100 and server 200 connected to client 100 via NW 1. Client 100 offloads processing of an application (user application part 131 in FIG. 1) that calls a plurality of functions with execution sequentiality to perform arithmetic processing to server 200 to perform the arithmetic processing. The functions with execution sequentiality include a callee function (for example, an enqueue function) for which subsequent execution is necessary and a subsequent function (for example, a dequeue function) that is subsequently executed after execution of the callee function. Server 200 includes: function execution part 233 that executes a designated function; a function call information reception part (function call information receiver-parser part 231 in FIG. 1) that extracts function call information including information capable of identifying a function (function name) and an argument(s) from data received from client 100; subsequent function necessity determination part 235 (FIG. 1) that determines whether a callee function is present in the information (function name) capable of identifying the function and the argument(s) received from function call information receiver-parser part 231; and subsequent function proxy execution part 236 (FIG. 1) that, when subsequent function necessity determination part 235 determines that a callee function is present, instructs function execution part 233 to perform proxy execution of the subsequent function corresponding to the callee function. Client 100 includes subsequent function call proxy responder part 136 (FIG. 1) that performs, for a subsequent function called by user application part 131, a response of the subsequent function as a proxy of the server side.

In this manner, arithmetic processing offload system 1000 completes execution of processing the subsequent function (e.g., a dequeue function) within server 200 and within client 100. With this, it is possible to reduce the number of functions to be called via NW 1, reduce the number of times of function calls via NW 1, to achieve low latency. It is possible to achieve both reduction in the number of times of function calls via NW 1 and low latency while maintaining the interface of the function.

Moreover, in arithmetic processing offload system 1000 (FIG. 1), server 200 includes: function execution part 233 that executes a designated function: the function call information reception part (function call information receiver-parser part 231 in FIG. 1) that extracts function call information including function name and an argument(s) from data received from client 100; subsequent function necessity determination part 235 (FIG. 1) that determines whether a callee function is present in the function name and the argument(s) received from function call information receiver-parser part 231: subsequent function proxy execution part 236 (FIG. 1) that, when subsequent function necessity determination part 235 determines that a callee function is present, instructs function execution part 233 to perform proxy execution of the subsequent function corresponding to the callee function.

In this manner, arithmetic processing offload system 1000 completes execution of processing the dequeue function processing within server 200. With this, it is possible to reduce the number of functions to be called via NW 1, minimize the number of times of function calls via NW 1, thereby to achieve low latency. In the example illustrated in FIG. 3, NW communication is reduced from four times (FIG. 15) to three times, and low latency and resource saving are achieved.

In addition, in arithmetic processing offload system 1000 (FIG. 1), client 100 includes subsequent function call proxy responder part 136 (FIG. 1) that, upon reception of a notification of an execution result of a callee function from the server 200 side, notifies user application part 131 of the response of the callee function for which the execution result has been received, and performs, for a subsequent function called by user application part 131 in response to the notification of the response of the callee function, a response of the subsequent function as a proxy of the server side.

As described above, client 100 of arithmetic processing offload system 1000 performs, until receiving the notification of the execution result of the callee function from server 200, a proxy response(s) to the dequeue function call(s) inside the client (completes responding to the dequeue function call(s) within the client until reception of the execution result from the server). With this, it is possible to reduce the number of times of function calls via NW 1. In addition, there is an effect that the function interface is maintained, there is no need to change the client app, and there is no need to change the interface operated by the client application.

In arithmetic processing offload system 1000, subsequent function call proxy responder part 136 (FIG. 1) of client 100, upon reception of a notification of an execution result of the callee function from the server 200 side, notifies user application part 131 of the response of the callee function for which the execution result has been received, and performs, for a subsequent function called by user application part 131 in response to the notification of the response of the callee function, a response of the subsequent function as a proxy of the server side.

In this manner, client 100 of arithmetic processing offload system 1000 performs a proxy response to a dequeue function call(s) inside the client (completes responding to the dequeue function call(s) within the client until reception of an execution result from the server). With this, it is possible to reduce the number of times of function calls via NW 1.

In arithmetic processing offload system 1000, subsequent function call proxy responder part 136 (FIG. 1), until the notification of the execution result of the subsequent function is received from the server 200 side, responds to the application (user application part 131 in FIG. 1) with an execution result of the subsequent function. As the response of the subsequent function, subsequent function call proxy responder part 136 responds, for example, with incompletion as the execution result of the subsequent function, and when a notification of the execution result of the subsequent function has been received, responds to user application part 131 with success as the execution result of the subsequent function. For the response of the execution result of the subsequent function, notification of the processing result is also made in addition to the success or failure of the function execution.

With this, on client 100 side, a proxy response to the dequeue function call(s) are performed inside the client. Until the notification of the execution result of the subsequent function is received from the server 200 side, subsequent function call proxy responder part 136 responds to user application part 131 with, for example, incompletion as the execution result of the dequeue function and, when having received the notification of the execution result of the dequeue function, responds with success as the execution result to complete the dequeue function response.

Here, in arithmetic processing offload system 1000, by including the above-described server 200 and client 100, it is possible to achieve both the minimization of the number of times of function calls via NW 1 and the low latency while maintaining the interface of the function in the offloading, via NW 1, of a plurality of functions with execution sequentiality, such as the enqueue function processing and the dequeue function processing.

In arithmetic processing offload system 1000 (FIG. 1), the functions with execution sequentiality are: an enqueue function intended for enqueuing that requires a subsequent execution(s); and a dequeue function intended for dequeuing that is subsequently executed after execution of the enqueue function.

With this, it can be applied to a client application “with limitations on the sequentiality of calling and completion of the previous function” such as the enqueue function and the dequeue function, and in that applying, there is an effect that the function interface is maintained and it is not necessary to make changes to the client app. Note that the functions with execution sequentiality may be a preparation function for preparation and an execution function executed after the execution of the preparation function, in which case a similar effect will be obtained.

Note that, of the processing described in the above embodiments, all or some pieces of the processing described as those to be automatically performed may be manually performed, or all or some pieces of the processing described as those to be manually performed may be automatically performed by a known method. In addition, processing procedures, control procedures, specific name, and information including various types of data and parameters illustrated in the specification and the drawings can be freely changed unless otherwise specified.

The constituent elements of the devices illustrated in the drawings are functionally conceptual ones and are not necessarily physically configured as illustrated in the drawings. In other words, a specific form of distribution and integration of individual devices is not limited to the illustrated form, and all or part thereof can be functionally or physically distributed and integrated in any unit according to various loads, usage conditions, and the like.

Some or all of the configurations, functions, processing parts, processing means, and the like described above may be implemented by hardware by, for example, being designed in an integrated circuit. Each of the configurations, functions, and the like may be implemented by software for interpreting and executing a program for causing a processor to implement each function. Information such as a program, table, and file for implementing each function can be held in a recording device such as a memory, hard disk, or solid state drive (SSD) or a recording medium such as an integrated circuit (IC) card, secure digital (SD) card, or optical disc.

### REFERENCE SIGNS LIST

1 Network (NW)
100 Client
110 Client HW
111 NIC
130 APL
131 User application part
132 Function call receiver-responder part
133 Subsequent function determination part
134 Function call information packetization-transmission part
135 Reception content determination-storage part
136 Subsequent function call proxy responder part
200 Server
210 Server HW
211 NIC
230 APL
231 Function call information receiver-parser part (function call information reception part)
232 Function proxy caller part
233 Function execution part
234 Function response information transmission part
235 Subsequent function necessity determination part
236 Subsequent function proxy execution part
237 Subsequent function result transmission part
1000 Arithmetic processing offload system

1-9. (canceled)

10. An arithmetic processing offload system comprising a client and a server connected to the client via a network such that the client offloads processing of an application that calls a plurality of functions with execution sequentiality to perform arithmetic processing to the server to perform the arithmetic processing, the plurality of functions with execution sequentiality including a callee function and a subsequent function to be subsequently executed after execution of the callee function,
wherein the server comprises:
a function execution part configured to execute a designated function;
a function call information reception part configured to extract function call information including information capable of identifying a function and an argument from data received from the client;
a subsequent function necessity determination part configured to receive the function call information from the function call information reception part and to determine whether the function call information indicates the callee function; and
a subsequent function proxy execution part configured to, when the subsequent function necessity determination part determines that the function call information indicates the callee function, instructs the function execution part to perform proxy execution of the subsequent function.

11. The arithmetic processing offload system according to claim 10,
wherein the client comprises a subsequent function call proxy responder part that performs, as a proxy of the server, a response to a call to the subsequent function by the application.

12. The arithmetic processing offload system according to claim 11,
wherein the subsequent function call proxy responder part is further configured to,
upon reception of a notification of an execution result of the callee function from the server, makes a notification to the application of a response of the callee function for which the execution result has been received, and
perform, as a proxy of the server, a response to a call to the subsequent function, the call made by the application in response to the notification of the response of the callee function.

13. The arithmetic processing offload system according to claim 11,
wherein the subsequent function call proxy responder part is further configured to,
until a notification of an execution result of the subsequent function is received from the server, perform, as a proxy of the server, a response to a call to the subsequent function, the call made by the application.

14. The arithmetic processing offload system according to claim 11,
wherein the callee function is an enqueue function intended for enqueuing that requires subsequent processing after calling the enqueue function, and
wherein the subsequent function is a dequeue function intended for performing the subsequent processing after execution of the enqueue function.

15. An arithmetic processing offload system comprising a client and a server connected to the client via a network such that the client offloads processing of an application that calls a plurality of functions with execution sequentiality to perform arithmetic processing to the server to perform the arithmetic processing, the plurality of functions with execution sequentiality including a callee function and a subsequent function to be subsequently executed after execution of the callee function,
wherein the client comprises a subsequent function call proxy responder part configured to,
upon reception of a notification of an execution result of the callee function from the server, makes a notification to the application of a response of the callee function for which the execution result has been received, and
respond, as a proxy of the server, to a call to the subsequent function, the call made by the application in response to the notification of the response of the callee function.

16. An arithmetic processing offload method of an arithmetic processing offload system comprising a client and a server connected to the client via a network such that the client offloads processing of an application that calls a plurality of functions with execution sequentiality to perform arithmetic processing to the server to perform the arithmetic processing, the plurality of functions with execution sequentiality including a callee function and a subsequent function to be subsequently executed after execution of the callee function, the arithmetic processing offload method comprising steps of:
extracting, by the server, function call information including information capable of identifying a function and an argument from data received from the client;
determining, by the server, whether the extracted function call information indicates the callee function;
when it is determined that the function call information indicates the callee function, performing, by the server as a proxy of the client, execution of the subsequent function; and
performing, by the client as a proxy of the server, a response to a call to the subsequent function by the application

17. A non-transitory computer-readable medium storing a computer program for causing a computer to function as the server of the arithmetic processing offload system according to claim 10.

18. A non-transitory computer-readable medium storing a computer program for causing a computer to function as the client of the arithmetic processing offload system according to claim 15.
